(19) United States
(12) Patent Application Publication
(10) Pub. No.: US 2006/0123930 A1
(43) Pub. Date: Jun. 15, 2006

(54) Method of dispensing liquid in a pipetting device and the pipetting device

(76) Inventors: Andrzej Czernecki, Warsaw (PL); Wojciech Wyszogrodzki, Warsaw (PL); Andrzej Jankowski, Warsaw (PL); Piotr Urban, Warsaw (PL)

Correspondence Address: PILLSBURY WINTHROP SHAW PITTMAN, LLP, P.O. BOX 10500, MCLEAN, VA, 22102, US

(21) Appl. No.: 10/540,213

(22) PCT Filed: Apr. 8, 2003
(86) PCT No.: PCT/PL03/00035

§ 371 Date: Jan. 20, 2006

(30) Foreign Application Priority Data
Jan. 14, 2003 (PL) P.358260

(51) Int. Cl. B01L 3/02; G01N 1/38

(52) U.S. Cl. 73/864.15; 73/863.02; 700/240

(57) ABSTRACT

In the method of dispensing liquid according to the invention, when liquid is aspired by the pump to the pipette, the required size of dose of the liquid is dispensed from the pipette in proportion to the atmospheric air fed thereto through a valve or a set of connected to the pipette, whereas the amount of supplied atmospheric air is processor programmed by the determination of time and/or flow rate and/or damping of the supply of atmospheric air into the pipette. Pipetting device according to the invenvention comprises a housing with a handle (3) for mounting the pipette (4), whereas in the housing, an air pump (6) is located, connected to the pipette (5), and a processor (15) to control the operation of the device. The pipetting device comprises also a set of valves (10) for processor (15) controlled atmospheric airflow during dispensing liquid, whereas the set of valves (10) is connected to the pipette (5).

### BACKGROUND OF THE INVENTION

1. Field of the Invention

This invention relates to the method of dispensing liquid in a pipetting device and the pipetting device.

2. Description of the Related Art

The German patent publication No. 3818704 discloses a pipetting device comprising a housing with a handle and a holder to mount a pipette. The device moreover comprises a suction assembly for aspirating liquid into the pipette, and an assembly for dispensing the aspirated liquid from the pipette such that the negative pressure from the device is released to atmosphere.

The U.S. Pat. publication No. 5,509,318 discloses an automatic device for filling a pipette, assigned to operate with a standard glass vessel or a plastic pipette, to aspirate and dispense a determined quantity of liquid, whereas the device comprises a housing with a handle and a holder to mount a pipette, electric motor, a peristaltic pump comprising a squeezable hose fixed in the housing and driven by the motor to effect the flow of liquid, tubing to connect the pump with the pipette holder, and a control system to control the motor and the pump.

Further, the U.S. Pat. No. 6,090,348 discloses a method of controlling an electronic device for filling a pipette in the manual mode of operation so as to simulate manual control of this device. The pipette filling device has the first operation button to aspirate liquid, and the second operation button to dose the liquid from the pipette mounted to this device, and a computerised system to control the manual operation mode of the device. In the method according to this invention, first the device for filling a pipette starts to operate, the computer control system is activated in manual operation mode, the pipette is immersed in liquid, the first button is depressed so the pipette filling device sucks the liquid in, and the pipette is removed from the liquid. Next the second button is depressed to dose the aspirated liquid by the pipette filling device, whereas the aspiration and dosing ratios are related to the value of forces applied to the first and the second button, and the computer system sets the pipette filling device in manual operation mode to control the rate of aspiration and dispensing so as to simulate manual pipette filling devices.

### SUMMARY OF THE INVENTION

According to the present invention, the method of dispensing liquid in a pipetting device comprises a housing with a holder to mount a pipette, whereas an air pump connected to the pipette, and a processor controlling the device operation is disposed in the housing, wherein after aspiration by the pump of liquid into the pipette, the required size of the liquid dose is dispensed form the pipette in proportion to the amount of atmospheric air supplied thereto through a valve or a set of valves connected to the pipette, where the amount of the supplied atmospheric air is programmed in the processor by determination of time and/or flow rate and/or damping of the supply of atmospheric air to the pipette.

Preferably the amount of air supplied to the pipette is determined basing on stored in the processor memory air flow function related to the type of liquid and/or pipette.

Preferably the amount of air supplied to the pipette is determined basing on stored in the processor memory standard air flow tables related to the type of liquid and/or pipette.

Preferably data concerning air flow are input to the processor memory from an external appliance.

Preferably the external appliance communicates with the pipetting device by wire or in wireless manner.

Preferably a programmable controller or a computer is applied as the external appliance.

According to the present invention, the pipetting device comprises a housing with a pipette mounting holder, whereas an air pump connected to the pipette is disposed in the housing, and it includes at least one valve for controlled atmospheric air flow during liquid dispensing, whereas this valve is connected to the pipette.

According to a variety of the present invention, the pipetting device comprises a housing with a pipette mounting holder, whereas an air pump connected to the pipette, and a processor controlling the operation of the device are disposed in the housing, and it includes a set of valves for processor controlled atmospheric air flow during liquid dispensing, whereas this set of valves is connected to the pipette.

Preferably the valve set output is connected between the air flow distributor connected to the air pump and controlled by the liquid aspirating button and the liquid dispensing button and the pipette.

Preferably it includes at least one air flow damper in the path of atmospheric air flow with the valve.

Preferably it includes a set of air flow dampers connected to the inlet of the set of valves.

Preferably a programmed dispensing button is connected to the processor with the display and function selection and function confirmation buttons.

Preferably the set of valves is controlled by the processor.

Preferably the air flow damper and/or the set of air flow dampers is controlled by the processor.

Preferably the processor is controlled from an external appliance.

Preferably it includes an air flow three-way pipe which is connected between the air flow distributing valve, the pipette and the outlet from the set of valves.

Preferably it includes a manifold which is connected between the output from the set of valves and the air flow three-way pipe.

Preferably the function of programmed dispensing button is after programmed switching by the processor taken over by the liquid aspiration button.

Preferably the processor includes stored in its memory air flow functions or standard air flow tables which take into account the type of used liquid and/or pipette.

The solution according to the invention ensures high accuracy of liquid dispensing, especially programmed dispensing of the pre-set liquid doses from the pipette of the pipetting device.

### BRIEF DESCRIPTION OF THE DRAWINGS

The accompanying drawings, which are incorporated in, and form a part of the specification, illustrate embodiments of the present invention and, together with the description, serve to explain the principles of the invention. In the drawings:

FIG. 1 shows the longitudinal section of pipetting device according to the invention;

FIG. 2 shows the diagram of functional links of elements of the pipetting device.

### DETAILED DESCRIPTION OF THE INVENTION

Reference will now be made in detail to the preferred embodiments of the invention, examples of which are illustrated in the accompanying drawings.

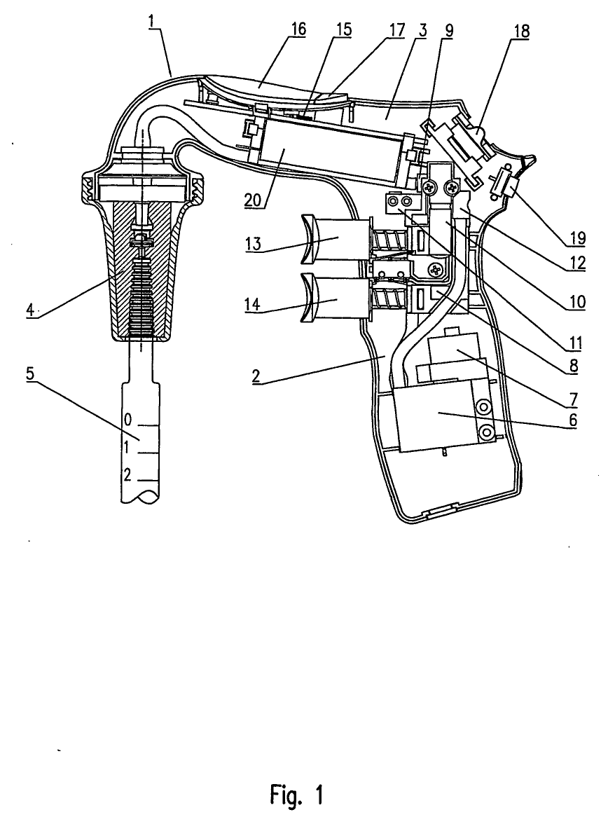

The pipetting device shown in the longitudinal section in the FIG. 1 has a housing (1) with a handle (2) and a sleeve (3), whereas the sleeve (3) is tipped with the holder (4) assigned to mount the pipette (5). In the handle (2) of the housing (1) an air pump (6) driven by a motor (7), an air flow distributing valve (8), an air flow three-way pipe (9), an assembly of valves (10), a set of air flow dampers (11), and a manifold (12) as well as a liquid aspiration button (13) and a liquid dispensing button (14) are disposed. In turn, in the sleeve (3) of the housing (1) of the device a processor (15), a display (16), function selection and function confirmation buttons (17) and (18), a programmed dosing button (19) and a rechargeable battery (20) are disposed.

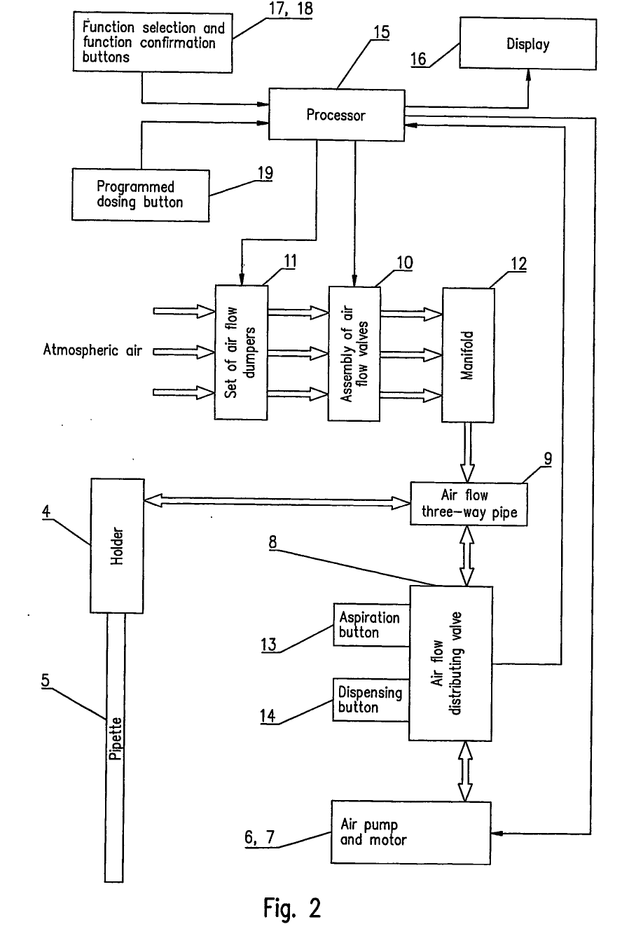

Functional links of the elements of the pipetting device are illustrated in the FIG. 2. The air pump (6) driven by the motor (7) powered from the rechargeable battery (20) is connected with an air tubing from the air flow distributing valve (8) controlled by the liquid aspiration button (13) and the liquid dispensing button (14). Next the outlet of the air flow distributing valve (8) is further connected with the air tubing through the air flow three-way pipe (9) to the holder (4) and the pipette (5) mounted therein. The described assembly is a known pipetting device.

In the pipetting device according to the preferred embodiment of the invention, an assembly of valves (10) is applied for controlled flow of atmospheric air during dispensing liquid from the pipette (5). The outlet of the assembly of valves (10) is connected by the means of an air tubing to the air flow three-way pipe (9), and further to the pipette (5) mounted to the holder (4), while the inlet to the assembly of valves (10) is at the same time the inlet of atmospheric air, whereas in the path of atmospheric air to the pipette (5) at the inlet to the assembly of valves (10) a set of air flow dampers (11) is disposed, while at the outlet from the assembly of valves (10) an atmospheric air manifold (12) is disposed.

The air pump (6), assembly of air flow valves (10), and set of air flow dampers (11) are controlled by the processor (15) which has stored in its memory air flow functions or standard air flow tables which take into account the type of used liquid and/or pipette (5). In turn, the processor (15) with the display (16) attached thereto is controlled by the function selection and function confirmation buttons (17) and (18), the programmed dispensing button (19), as well as the liquid aspirating button (13) and the liquid dispensing button (14) from the air flow distribution valve (8). The application of the programmed dispensing button (19) in another embodiment of the pipetting device according to the invention is not necessary if its functions are taken over by the liquid aspirating button (13) after programmed switching by the processor (15), which aspirating function is restored when the programmed sequence is finished or when the liquid dispensing button (14) is pressed.

The method of dispensing liquid from the pipette by the pipetting device according to the invention is accomplished as follows. Primarily to the memory of the processor (15) data regarding the device operational procedure are input in the form of air flow functions or air flow standard tables related to the used liquid and/or applied pipette (5). The device operational procedure comprises the quantity of atmospheric air supplied to the pipette (5) which is related mainly to the time of feeding, flow rate and damping of atmospheric air supply. Operational procedure data may be entered directly to the pipetting device using its buttons, or from an external appliance. The external appliance may communicate then with the pipetting device by wire or wirelessly, especially by radio signals or in optical way, whereas preferably a programmable controller or a computer is applied as the external appliance.

After aspirating liquid into the pipette (5), on depressing the aspiration button (13) and by the use of the air pump (6), the programmed dosing procedure is carried out. By the function selection and function confirmation buttons (17, 18) with simultaneous examination of the data read-out from the display (16), pipette (5) data can be selected, or automatic selection is confirmed. Next operational procedures are selected, e. g. normal operation, operation to the factory pre-set programme, or operation to the user's own programme. Within the framework of operations to the factory pre-se programme or user's own programme, titration, serial dispensing of the same quantity of liquid, or serial dispensing of various quantities of liquid may be selected. Depending on the selected procedure, pipette, liquid or another parameter, the processor (15) determines the time and/or rate of supply of atmospheric air, and the magnitude of introduced damping appropriate for the dose to be dispensed. Information regarding the pipetting device operational state are displayed on the display (16). Depressing the programmed dispensing button (19) caused the dispensing of the programmed liquid dose, whereas for the sake of ensuring safety of work, release of this button denotes discontinuation of the process of dispensing liquid. In order to return to the procedure, the remaining liquid must be blown out by depressing the dispensing button (14), and next in the programmed way the liquid must be aspired by depressing the aspiration button (13). In order to make it impossible to flood the pipette (5), depressing of the aspiration button (13) will not result in programmed liquid aspiration unless the dispensing button (14) is depressed beforehand. Subsequent pressing and holding the programmed dispensing button (19) results during dispensing subsequent programmed volumes of liquid, whereas each time dispensing of the programmed quantity of liquid is accomplished by opening for a determined time of an appropriate valve from the set of valves (10) connected with thereto assigned air flow damper from the set of air flow dampers (11), whereas both, the set of valves (10), and the set of air flow dampers (11) are processor (15) controlled.

In another preferred embodiment of the invention the pipetting device comprising a housing (1) with a holder (4) for mounting a pipette (5), and located in the housing (1) an air pump (6) connected to the pipette (5), includes a valve for controlled flow of atmospheric air during liquid dispensing, whereas this valve is connected to the pipette (5). Moreover it includes an air flow damper in the atmospheric air flow path with such valve. In this embodiment both, the atmospheric air flow control valve for liquid dispensing, and the air flow damper may be controlled by an analogue signal or a digital signal, for example from the processor (15).

1. The method of dispensing liquid in a pipetting device comprising a housing with a holder to mount a pipette, whereas an air pump connected to the pipette, and a processor controlling the device operation is disposed in the housing, wherein after aspiration by the pump of liquid into the pipette, the required size of the liquid dose is dispensed form the pipette in proportion to the amount of atmospheric air supplied thereto through a valve or a set of valves connected to the pipette, characterized by that the amount of the supplied atmospheric air is programmed in the processor by determination of time and/or flow rate and/or damping of the supply of atmospheric air to the pipette.

2. The method according to the claim 1 characterized by that the amount of air supplied to the pipette is determined basing on stored in the processor memory air flow function related to the type of liquid and/or pipette.

3. The method according to the claim 1 characterized by that the amount of air supplied to the pipette is determined basing on stored in the processor memory standard air flow tables related to the type of liquid and/or pipette.

4. The method according to the claim 2 characterized by that data concerning air flow are input to the processor memory from an external appliance.

5. The method according to the claim 4 characterized by that the external appliance communicates with the pipetting device by wire or in wireless manner.

6. The method according to the claim 4 characterized by that a programmable controller or a computer is applied as the external appliance.

7. The pipetting device comprising a housing with a pipette mounting holder, whereas an air pump connected to the pipette is disposed in the housing, characterized by that it includes at least one valve for controlled atmospheric air flow during liquid dispensing, whereas this valve is connected to the pipette (5).

8. The pipetting device comprising a housing with a pipette mounting holder, whereas an air pump connected to the pipette, and a processor controlling the operation of the device are disposed in the housing, characterized by that it includes a set of valves (10) for processor (15) controlled atmospheric air flow during liquid dispensing, whereas this set of valves (10) is connected to the pipette (5).

9. The device according to the claim 8 characterized by that the valve set (10) output is connected between the air flow distributor (8) connected to the air pump (6) and controlled by the liquid aspirating button (13) and the liquid dispensing button (14), and the pipette (5).

10. The device according to the claim 7 characterized by that it includes at least one air flow damper in the path of atmospheric air flow with the valve.

11. The device according to the claim 8 characterized by that it includes a set of air flow dampers (11) connected to the inlet of the set of valves (10).

12. The device according to the claim 8 characterized by that a programmed dispensing button (19) is connected to the processor (15) with the display (16) and function selection and function confirmation buttons (17, 18).

13. The device according to the claim 8 characterized by that the set of valves (10) is controlled by the processor (15).

14. The device according to the claim 10 characterized by that the air flow damper and/or the set of air flow dampers (11) is controlled by the processor (15).

15. The device according to the claim 13 characterized by that the processor (15) is controlled from an external appliance.

16. The device according to the claim 9 characterized by that it includes an air flow three-way pipe (9) which is connected between the air flow distributing valve (8), the pipette (5) and the outlet from the set of valves (10).

17. The device according to the claim 16 characterized by that it includes a manifold (12) which is connected between the output from the set of valves (10) and the air flow three-way pipe (9).

18. The device according to the claim 12 characterized by that the function of programmed dispensing button (19) is after programmed switching by the processor (15) taken over by the liquid aspiration button (13).

19. The device according to the claim 8 characterized by that the processor (15) includes stored in its memory air flow functions or standard air flow tables which take into account the type of used liquid and/or pipette.
